(19) United States
(12) Patent Application Publication
(10) Pub. No.: US 2015/0257950 A1
(43) Pub. Date: Sep. 17, 2015

(54) UPRIGHT WHEELCHAIR WITH A CHASSIS, AND A SEAT ARRANGED PIVOTABLY ON THE CHASSIS

(71) Applicant: Handicare B.V., Helmond (NL)

(72) Inventors: Marcus Petrus Hendricus Ten Holter, Helmond (NL); Johannes Engelmundus Leonardus Mathias Josten, Helmond (NL); Jean Johannes Josephus Wilhelmus Brouns, Helmond (NL); Antonius Engelbert Marie Peeters, Helmond (NL)

(21) Appl. No.: 14/645,744

(22) Filed: Mar. 12, 2015

(30) Foreign Application Priority Data
Mar. 13, 2014 (NL) 2012427

(51) Int. Cl. A61G 5/14; A61G 5/10

(52) U.S. Cl. CPC A61G 5/14; A61G 5/1072

(57) ABSTRACT

An upright wheelchair having a chassis and a seat pivotably arranged on the chassis, the seat configured to be pivoted about a pitch axis from a substantially horizontal seating position to a substantially vertical standing position. The upright wheelchair may further include a footrest and pivoting means arranged such that, in at least the vertical standing position, the seat is pivotable with respect to the chassis about a yaw axis that is substantially parallel to vertical.

### TECHNICAL FIELD AND BACKGROUND OF THE INVENTION

The present invention relates to an upright wheelchair with a chassis, and a seat arranged pivotably on the chassis, wherein the seat can be pivoted from a substantially horizontal seating position to a standing position.

A type of upright wheelchair is known for example from EP 0 815 822 B1. GB 2 307 213 A discloses a transfer system for a wheel chair. U.S. Pat. No. 5,096,008 A discloses a rotatable stand-up wheelchair.

The seated posture of a wheelchair occupant maintained over a long period results in physical breakdown of bodily functions, such as for example reduced mobility of the lower limbs, a slowdown in bowel activity and impairment to blood circulation. Sitting also adds the risk of bedsores. An upright wheelchair aids in reducing these consequences, since the breakdown of bodily functions is reduced by changing posture, including standing. The pivoting seat area is mounted with a back and footrest on a chassis. Correctly adapting to the anatomical requirements of the user is a vital criterion for comfort offered by the wheelchair.

Upright wheelchairs also offer the user the option of taking part in sports that require an upright position, such as playing golf. In prior art wheelchairs, a high degree of standing stability in the upright position is provided. The footrest stands on the ground or is supported thereon when the wheelchair is in the upright position. The seat area is pivoted upwards, and room is provided for the upper body of the user to move. For instance, a user playing golf is able to make a swing that mainly originates from arm movement.

Playing sports such as golf in an upright wheelchair requires a lot of energy. Additionally, a lot of stress is provided on the body of the user. This is undesirable, as it may increase the risk of injuries.

### BRIEF SUMMARY OF THE INVENTION

It is therefore an object of the invention to provide an improved upright wheelchair, with which the risk of injuries for a user during the playing of sports is reduced.

To this end, the invention provides an upright wheelchair. According to the invention, in at least the standing position, the seat is pivotable with respect to the chassis about a yaw axis that is substantially parallel to the vertical. With this, the upright wheelchair according to the invention is arranged for allowing the user to pivotally move about the vertical axis in at least the standing position, which allows the user to pivot the body during sports. To provide for a more natural movement, and in order to prevent unnecessary strain on the body, the pivoting movement of the seat with respect to the chassis, about the yaw axis, is limited. The wheelchair additionally comprises damping and/or spring means for damping the pivoting movement of the seat with respect to the chassis. In playing golf, for example, these features allow for a more natural movement of the body during performing a swing, and it also allows for the forces that occur during a golf swing, to be distributed over a greater part of the body, leading to less stress on individual body parts. Thus, the more natural movement and the greater distribution of forces over the body, lead to less risk of injuries, with which an object of the invention is achieved.

It is noted in this respect that the standing position is to be understood as a position which is more upright, compared to the seating position. The standing position may be a substantially vertical standing position, but is not limited thereto.

It is noted in general that the invention will in particular be explained with respect to playing golf, and based on movements occurring in playing golf. The invention is by no means however limited to this type of sports. It should be understood that the upright wheelchair according to the invention is suitable to be used in other sports as well, wherein similar types of movements may be exerted by a user, and wherein the wheelchair according to the invention provides less strain on the body, thus diminishing or at least lessening the risk of injuries. It will further be understood that modifications to the wheelchair according to the invention may be made, in order to better suit a particular type of sports, without departing from the invention.

Advantageous embodiments of the upright wheelchair according to the invention will be explained below.

The damping and/or spring means may in particular be arranged for damping the pivoting movement near at least one of the end points of said limited pivoting movement. For example, the damping and/or spring means may provide damping near the end point associated with the follow through of the golf swing, such that part of the forces occurring during movement are taken up by the damping means as well, lessening the risk of injury for the user. Likewise, a damping of the pivoting movement during the backswing in golf, for example, may additionally, or alternatively, be provided. Of course, the damping movement may be beneficial in other sports as well.

To allow an easy pivoting movement about the yaw axis, the upright wheelchair comprises, in an embodiment, a hand support that is fixedly connected to the chassis, wherein the hand support is positioned and arranged near the seat in such a way as to allow the user to manually pivot the seat about the yaw axis. The user may use his arm to grab the hand support, and will be able to make a pivoting movement by pushing or pulling the hand support.

In a preferred embodiment, the seat is arranged to be fixed with respect to the chassis in at least the horizontal seating position, in order to prevent pivoting of the seat about the yaw axis. Thus, a stable seat is obtained in the seating position.

To this end, stop means may be provided to prevent pivoting of the seat about the yaw axis in at least the horizontal seating position.

In this sense, it is conceivable that the seat is pivotable with respect to the chassis about the yaw axis over an angle that is less than 180°, and in particular less than 120°. This range provides for a more natural movement in playing sports, in particular in playing golf. In other sports, other angles are conceivable.

It is furthermore conceivable that in the standing position, starting from a natural, non-pivoted position, the seat of the wheelchair may perform a pivoting movement in a clockwise direction, and a pivoting movement in the opposite, counter-clockwise direction, wherein the angle of rotation in the clockwise direction and the counter-clockwise direction, with respect to the natural, non-pivoted position, is equal in magnitude. This provides a symmetrical range of pivoting movement with respect to the natural position.

In an advantageous embodiment, which allows to better simulate a natural sporting movement, the wheelchair is arranged for allowing a non-symmetrical range of pivoting movement with respect to the natural position. For instance, this allows the range of pivoting to be greater for the backswing compared to the follow-through, for example, or vice versa. In the backswing, for example an angle of approximately 45° may be used, and in the follow-through an angle of approximately 80° may be used. In other sports, other values/ranges are possible as well.

The wheelchair according to the invention may comprise a footrest. The footrest is connected to the seat. In prior art wheelchairs, the footrest plane must be lying on the ground, for the wheelchair to be secure in the standing position. According to the invention, however, the footrest is arranged to be at a distance from the ground, to allow for a pivoting movement of the seat including the footrest, in at least a vertical standing position of the upright wheelchair.

In an embodiment, the upright wheelchair comprises retaining means that are arranged for preventing pivoting of the seat about the yaw axis in at least the vertical standing position when a force exerted on the seat is under a pivoting threshold value, and which is arranged for allowing pivoting of the seat about the yaw axis in at least the vertical standing position when a force exerted on the seat exceeds the pivoting threshold value. In particular, the retaining means may be arranged for preventing pivoting of the seat about the yaw axis only when the seat is near an end point of said limited pivoting movement. For example, the retaining means may provide retention near the end point associated with the back swing of the golf swing, allowing the user to use two hands for playing golf whilst providing more stability during movement of the seat. The user may then initiate the back swing, which moves the seat towards the end point. In this end point, the retaining means are activated, preventing further forward or backward pivoting of the seat about the yaw axis. The user continues the swing, and initiates the forward swing. This leads to a build up of force on the seat, and eventually the force exceeds the pivoting threshold value such that the seat is able to pivot about the yaw axis. The use of the retaining means ensure that the user experiences a more natural golf swing. Of course, the use of the retaining means may be beneficial in other sports as well. The pivoting threshold value may be set beforehand, or may be determined empirically for each user, by setting a value and checking whether that value is correct, and, if not, adjusting the pivoting threshold value.

In an embodiment, the retaining means comprises a magnet, in particular an electromagnet. This provides for an easy and reliable manner for establishing the retaining means and the desired pivoting threshold value. The magnet, or electromagnet, may be easily positioned such that the seat is accurately retained near an end point of the pivoting movement.

The retaining means may also comprise a clamping or a clip element for retaining the seat accurately near an end point of the pivoting movement. The clamping element may be placed onto the seat or onto the chassis or the like. Once the seat is retained in its end point position, a force exceeding the pivoting threshold value, i.e. the clamping force, will release the seat resulting in a pivoting movement around the yaw axis of the seat.

### BRIEF DESCRIPTION OF THE DRAWINGS

An embodiment of the invention will be described in greater detail by means of the accompanying figures, in which:

FIG. 1 schematically shows an isometric view of an upright wheelchair in the seating position;

FIG. 2 shows an isometric view of the upright wheelchair of FIG. 1 in the standing position;

FIG. 3a shows an isometric view of the upright wheelchair of FIG. 1 in the standing position, wherein the seat is pivoted about the yaw axis;

FIG. 3b shows a detail of the upright wheelchair of FIG. 3a;

FIG. 4 shows an isometric view of the upright wheelchair of FIG. 1 in the standing position, wherein the seat is pivoted about the yaw axis;

### DETAILED DESCRIPTION OF THE INVENTION

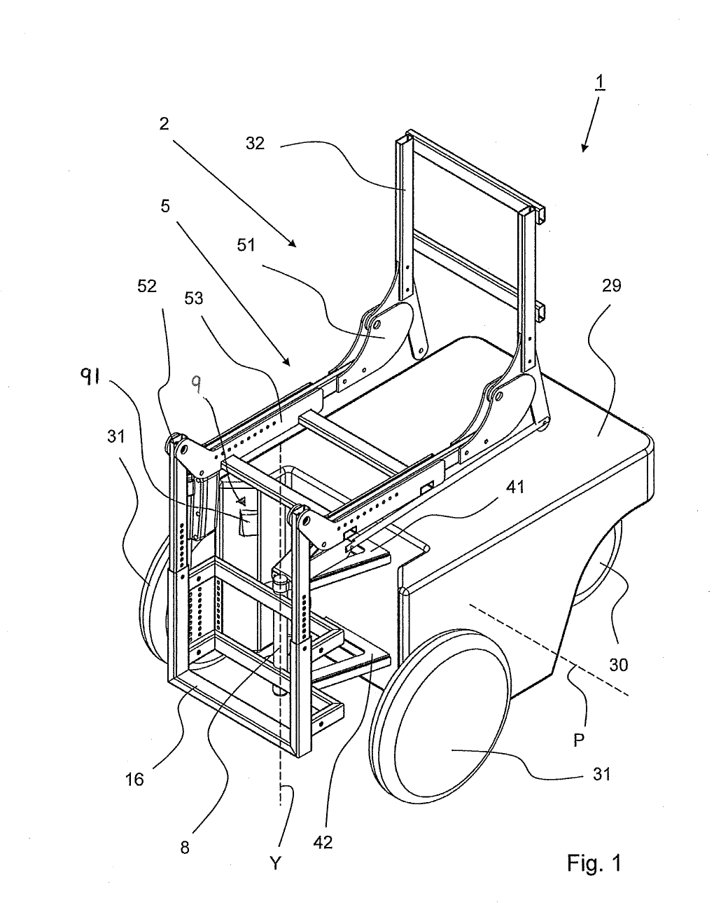

FIG. 1 shows an upright wheelchair 1 according to an embodiment of the invention. The wheelchair 1 is shown in the seating position, and comprises a chassis 29, having a chair 2 set on it, wherein the chassis is provided with a rear wheel 30 and two front wheels 31. The chair 2 comprises a frame, which is visible in the figures. Padding (not visible in the figures for clarity purposes) is provided on the frame, such that a comfortable chair 2 is provided on the chassis 29. The chair 2 has a seat 2, with a seat back 32 and a footrest 16. The chair 2 is connected to the chassis 29 by means of two supporting arms 41, 42.

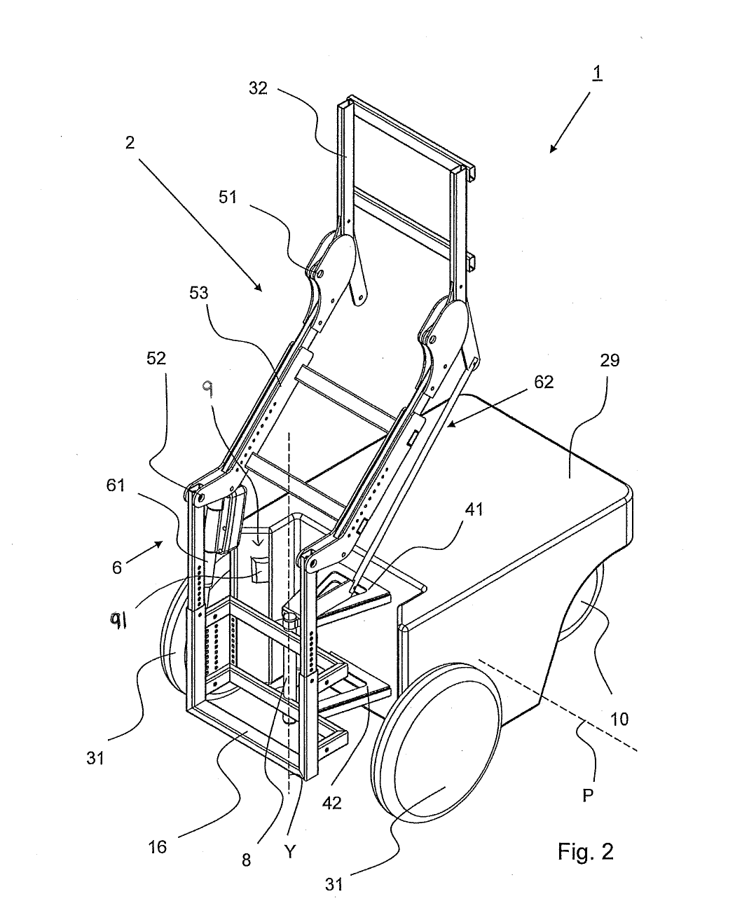

FIG. 2 shows the upright wheelchair 1 in the substantially vertical standing position. Here, the seat 2 is directed upwards. An actuator 61 is provided, and the seat comprises a linking mechanism 62 and link bars 53, with pivot axles 51, 52, such that the upwards movement is possible. Thus, the seat 2 may be pivoted upwards, about pivot axis P which is substantially parallel to the wheel axes. The seat area of the seat 2 thus reaches a more vertical position. The seat back 32 substantially maintains a parallel position with respect to the footrest 16. The centre of gravity is in the standing position between the rear wheel 30 and the front wheels 31.

It is noted that the standing position shown in FIG. 2 is a position which is more upright, compared to the seating position shown in FIG. 1. The standing according to the invention is not limited to the standing position shown in FIG. 2. For instance, the standing position can be a position in which the seat 2 reaches a substantially vertical position.

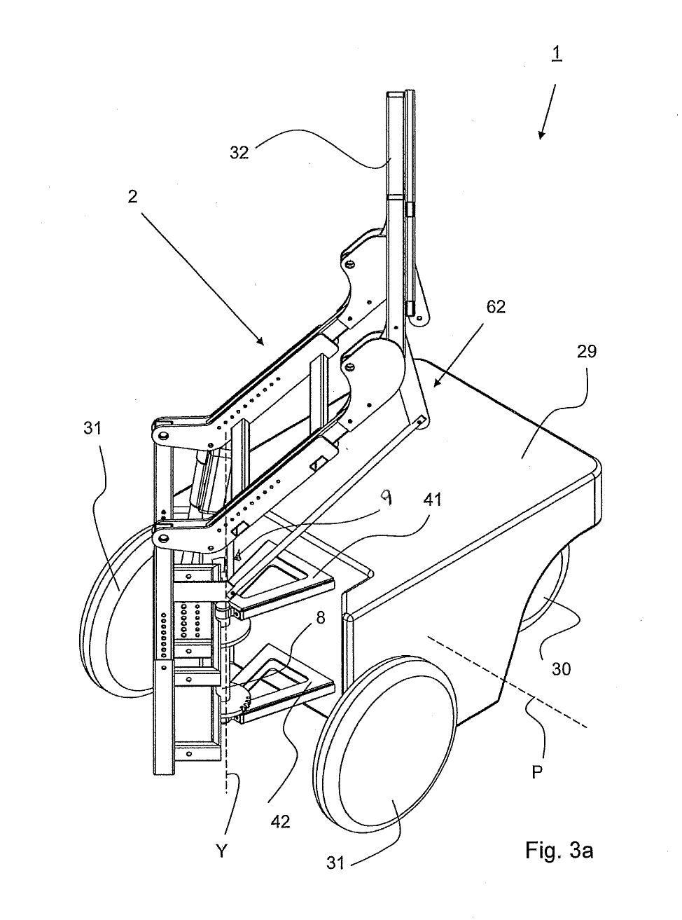

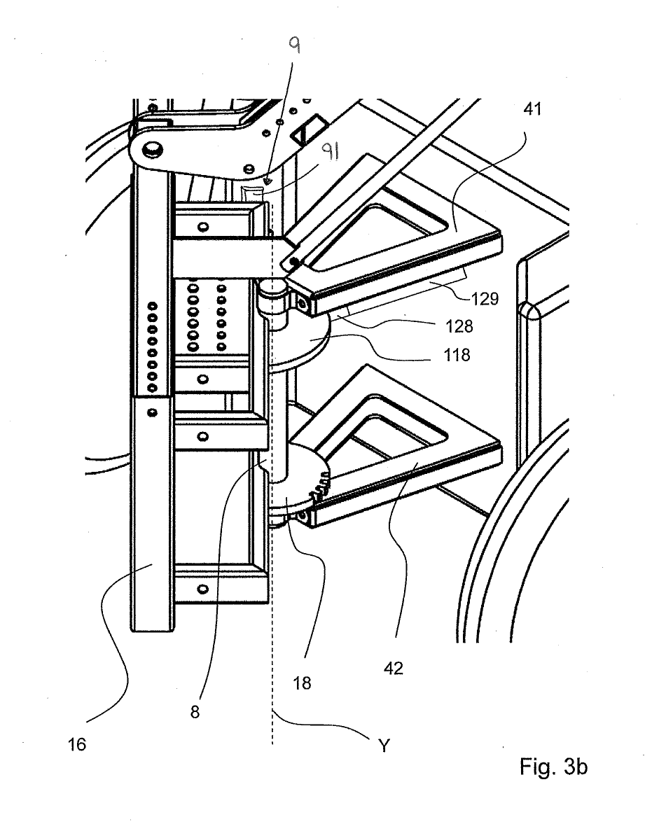

As best shown in FIG. 3, the wheelchair 1 according to the invention is provided with pivoting means 8 that are arranged such that, in at least the vertical standing position, the seat 2 is pivotable with respect to the chassis 29 about a yaw axis Y that is substantially parallel to the vertical. The pivoting means 8 comprise an axle 8 connected to an outer end of the supporting arms 41, 42. With this, the axis of rotation about the yaw axis Y lies substantially between the back rest 32 and the footrest 16, and preferably substantially closer to the footrest 16, to provide a natural pivoting movement for the user.

FIG. 3b shows a detail of the pivoting means 8 of the upright wheelchair 1. The pivoting means 8 comprise an axle 8, having two disks, wherein recesses 18 are provided in the lower disk. These recesses 18 may be used in forming stop means to prevent pivoting of the seat 2 about the yaw axis Y in at least the horizontal seating position. Thus, it is preferred that the wheelchair as shown in FIG. 1 is not pivotable about the yaw axis Y.

The recesses 18, may further be used to limit the pivotable movement of the seat 2 with respect to the chassis 29 about the yaw axis Y. It is furthermore conceivable that the seat 2 and the supporting arms 41, 42 and/or the chassis 29, comprise stop surfaces that limit the range of pivotable movement of the seat 2 with respect to the chassis 29. Other ways of establishing a limited range of pivoting movement are possible as well, and will be known to those skilled in the art.

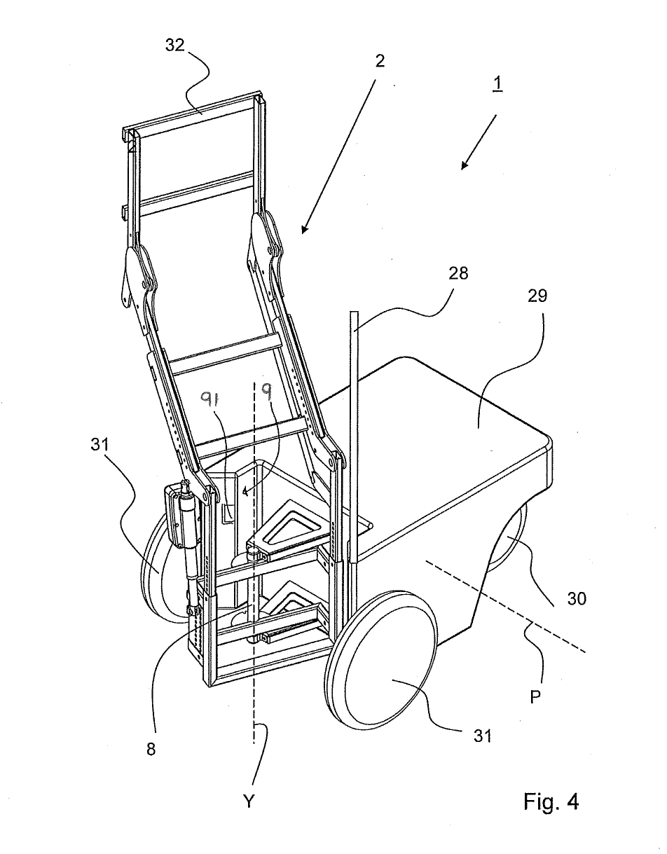

In the embodiment shown in FIG. 3a, the seat is pivoted to the right-hand-side of the user, over an angle of approximately 45°. As can be seen in FIG. 4, the seat is pivotable to the left-hand-side of the user as well, over an angle of approximately 80°. Here, a non-symmetrical range of pivoting movement, with respect to the neutral position as shown in FIG. 2, is used, although it is of course possible to use a symmetrical range of pivoting movement.

The pivoting movement between the right-side (FIG. 3a) and the left side (FIG. 4), allows the user to perform a more natural sporting movement, for instance during the execution of a golf swing. The pivoting movement of the axle 8 is to this end preferably damped by means of damping means 8, which may be provided in the axle 8 itself.

In FIG. 3b, the damping means 8 consist of a disk-like cam-element 118 provided on the axle 8, near the upper support arm 41, and a damper 128, 129 that is fixedly connected to the upper support arm 41. The damper 128, 129 has a fixed part 129 and a movable (damping) part 128 that is—in the embodiment shown—telescopically movable within the fixed part 129. The damping part 128 is abutting the cam 118. The cam is provided with a curve, such that, when the seat pivots, the cam element 118 pushes or releases the damper part 128, such that more or less damping is obtained.

Pivoting movement of the seat 2 may be executed manually by the user. To that end, a hand support 28 is preferably provided, as best seen in FIG. 4. It should be noted that the embodiments shown in FIGS. 1 to 3, preferably also comprise the hand support 28, even though for clarity purposes this hand support 28 is not shown in these figures.

The hand support 28 may be extendable in an upwards/downwards direction, to allow the hand support 28 to be stored in the seating position. The hand support 28 may be arranged telescopically, for instance.

It is noted that the footrest 16 is located at a distance from the ground, making it possible to drive and pivot the wheelchair in the standing position.

It is furthermore noted that the wheelchair described above comprises three wheels. The front wheels 31 are preferably drive wheels 31, and the rear wheel 30 is preferably a steering wheel 30 as this provides a stable basis for pivoting movement of the seat 2. However, other arrangements of the wheels 30, 31 with regards to number of wheels, and/or steering of the wheels 30, 31 are conceivable. The invention is not limited to these variations.

It is furthermore noted that the mechanism with which the seat may be pivoted about the pivot axis P, from a seating position to a vertical standing position, may vary as well. In principle, those mechanisms are known to those skilled in the art.

Referring back to FIG. 1-4, and in particular to FIG. 3b, it can be seen that the wheelchair comprises retaining means 9 that are arranged for preventing pivoting of the seat 2 about the yaw axis Y in at least the vertical standing position when a force exerted on the seat is under a pivoting threshold value, and which is arranged for allowing pivoting of the seat 2 about the yaw axis Y in at least the vertical standing position when a force exerted on the seat exceeds the, pivoting threshold value. Here, the retaining means 9 comprise a magnet 91, in particular an electromagnet 91 that is arranged for holding the seat 2 (by means of a magnetic force acting on a metal part of the chassis 29, or vice versa) in a particular angular position, in FIG. 3b a position near an end point of pivoting movement. Here, the retaining means 9 are arranged for preventing pivoting of the seat about the yaw axis Y only when the seat is near the end point shown in FIG. 3b. The desired pivoting threshold value may be easily set by choosing a particular magnetic force, for instance by means of using a proper electromagnet. The retaining means are thus arranged for holding the seat in a particular position for a particular duration, during pivoting movement of the seat, for example during a golf swing.

Variations of the upright wheelchair according to the invention are conceivable. The scope of protection is determined by the appended claim set.

1. An upright wheelchair having a chassis and a seat pivotably arranged on the chassis, the seat configured to be pivoted about a pitch axis from a substantially horizontal seating position to a substantially vertical standing position, wherein the upright wheelchair comprises pivoting means arranged such that, in at least the vertical standing position, the seat is pivotable with respect to the chassis about a yaw axis that is substantially parallel to vertical, wherein the pivotable movement of the seat with respect to the chassis about the yaw axis is limited, and wherein the upright wheelchair comprises damping and/or spring means for damping the pivotable movement of the seat with respect to the chassis about the yaw axis.

2. The upright wheelchair according to claim 1, further comprising a hand support fixed to the chassis, wherein the hand support is positioned and arranged near the seat in such a way as to allow a user to manually pivot the seat about the yaw axis.

3. The upright wheelchair according to claim 1, wherein in at least the horizontal seating position, the seat is arranged to be fixed with respect to the chassis to prevent pivoting of the seat about the yaw axis.

4. The upright wheelchair according to claim 3, further comprising stop means for preventing pivoting of the seat about the yaw axis in at least the horizontal seating position.

5. The upright wheelchair according to claim 1, wherein the seat is pivotable with respect to the chassis about the yaw axis over an angle that is less than 180°.

6. The upright wheelchair according to claim 1, wherein the seat is pivotable with respect to the chassis about the yaw axis over an angle that is less than 120°.

7. The upright wheelchair according to claim 1, wherein the damping and/or spring means are arranged for damping the pivotable movement of the seat with respect to the chassis about the yaw axis near at least one end point of the limited pivotable movement.

8. The upright wheelchair according to claim 1, wherein the upright wheelchair comprises retaining means arranged for preventing pivoting of the seat about the yaw axis in at least the vertical standing position when a force exerted on the seat is under a pivoting threshold value, and is arranged for allowing pivoting of the seat about the yaw axis in at least the vertical standing position when a force exerted on the seat exceeds the pivoting threshold value.

9. The upright wheelchair according to claim 8, wherein the retaining means comprises a magnet.

10. The upright wheelchair according to claim 8, wherein the retaining means comprises an electromagnet.
